(19) United States
(12) Patent Application Publication
(10) Pub. No.: US 2024/0160469 A1
(43) Pub. Date: May 16, 2024

(54) BATCH SCHEDULING-BASED APPLICATION SCHEDULING METHOD, APPARATUS, AND SYSTEM

(71) Applicant: Alipay (Hangzhou) Information Technology Co., Ltd., Hangzhou (CN)

(72) Inventors: Zaibin HU, Hangzhou (CN); Tongkai YANG, Hangzhou (CN); Wei WU, Hangzhou (CN); Hao DAI, Hangzhou (CN); Denghui LI, Hangzhou (CN); Jun DU, Hangzhou (CN); Zhigang WANG, Hangzhou (CN); Weiyu TAN, Hangzhou (CN)

(21) Appl. No.: 18/505,990

(22) Filed: Nov. 9, 2023

(30) Foreign Application Priority Data
Nov. 10, 2022 (CN) 202211404430.0

(51) Int. Cl. G06F 9/50

(52) U.S. Cl. CPC G06F 9/5027

(57) ABSTRACT

Embodiments of this specification provide batch scheduling-based application scheduling methods, apparatuses, and systems. In the batch scheduling-based application scheduling method, an application scheduling request is received from a client, where the application scheduling request includes description information used to indicate a chain invoking relationship between applications to be scheduled; the applications to be scheduled are grouped into at least one scheduling object group based on the chain invoking relationship, where applications to be scheduled that are located in the same scheduling object group have the same chain invoking relationship; and the applications to be scheduled are scheduled to a target node by using the scheduling object group as a unit.

### TECHNICAL FIELD

Embodiments of this specification generally relate to the field of computer technologies, and in particular, to batch scheduling-based application scheduling methods, apparatuses, and systems.

### BACKGROUND

With rapid development of big data and Internet technologies, technologies such as cloud platforms and microservices are increasingly widely used. Due to the increasing expansion of services, dozens or hundreds of applications are usually needed to support complete functions.

### SUMMARY

In view of the above, embodiments of this specification provide batch scheduling-based application scheduling methods, apparatuses, and systems. According to the methods, the apparatuses, and the systems, applications to be scheduled that have the same chain invoking relationship can be deployed in scheduling objects in a scheduling object group running on the same physical machine, thereby significantly reduce communication resources.

According to an aspect of the embodiments of this specification, a batch scheduling-based application scheduling method is provided, including: An application scheduling request is received from a client, where the application scheduling request includes description information used to indicate a chain invoking relationship between applications to be scheduled; the applications to be scheduled are grouped into at least one scheduling object group based on the chain invoking relationship, where applications to be scheduled that are located in the same scheduling object group have the same chain invoking relationship; and the applications to be scheduled are scheduled to a target node by using the scheduling object group as a unit.

According to another aspect of the embodiments of this specification, a batch scheduling-based application scheduling apparatus is provided, including: an interface providing unit, configured to receive an application scheduling request from a client, where the application scheduling request includes description information used to indicate a chain invoking relationship between applications to be scheduled; a group control unit, configured to group the applications to be scheduled into at least one scheduling object group based on the chain invoking relationship, where applications to be scheduled that are located in the same scheduling object group have the same chain invoking relationship; and an object group scheduling unit, configured to schedule the applications to be scheduled to a target node by using the scheduling object group as a unit.

According to still another aspect of the embodiments of this specification, a batch scheduling-based application scheduling system is provided, including: the previous application scheduling apparatus; and a node proxy apparatus, configured to manage each scheduling object in the scheduling object group and a container that is in each scheduling object and that is used to run an application to be scheduled.

According to another aspect of the embodiments of this specification, a computer-readable storage medium is provided. The computer-readable storage medium stores a computer program, and when the computer program is executed by a processor, the batch scheduling-based application scheduling method described above is implemented.

According to another aspect of the embodiments of this specification, a computer program product is provided, including a computer program, and the computer program is executed by a processor to implement the batch scheduling-based application scheduling method described above.

### BRIEF DESCRIPTION OF DRAWINGS

The essence and advantages of the content in this specification can be further understood by referring to the following accompanying drawings. In the accompanying drawings, similar components or features can have the same reference numerals.

FIG. 1 shows an example architecture of a batch scheduling-based application scheduling method, apparatus, and system, according to one or more embodiments of this specification;

FIG. 2 is an example flowchart illustrating a batch scheduling-based application scheduling method, according to one or more embodiments of this specification;

FIG. 3 is another example flowchart illustrating a batch scheduling-based application scheduling method, according to one or more embodiments of this specification;

FIG. 4 is an example flowchart illustrating an application scheduling process, according to one or more embodiments of this specification;

FIG. 5 is still another example flowchart illustrating a batch scheduling-based application scheduling method, according to one or more embodiments of this specification;

FIG. 6 is an example schematic diagram illustrating an application scenario of a batch scheduling-based application scheduling method, according to one or more embodiments of this specification;

FIG. 7 is an example block diagram illustrating a batch scheduling-based application scheduling apparatus, according to one or more embodiments of this specification;

FIG. 8 is an example block diagram illustrating an object group scheduling unit in a batch scheduling-based application scheduling apparatus, according to one or more embodiments of this specification;

FIG. 9 is an example schematic diagram illustrating a batch scheduling-based application scheduling system, according to one or more embodiments of this specification; and

FIG. 10 is an example schematic diagram illustrating a batch scheduling-based application scheduling apparatus, according to one or more embodiments of this specification.

### DESCRIPTION OF EMBODIMENTS

The subject matter described here is discussed below with reference to example implementations. It should be understood that these implementations are merely discussed to enable a person skilled in the art to better understand and implement the subject matter described in this specification, and are not intended to limit the protection scope, applicability, or examples described in the claims. The functions and arrangements of the elements under discussion can be changed without departing from the protection scope of the embodiment content of this specification. Various processes or components can be omitted, replaced, or added in the examples as needed. In addition, features described for some examples can also be combined in other examples.

As used in this specification, the term “include” and its variant represent open terms, meaning “including but not limited to”. The term “based on” means “at least partially based on”. The terms “one embodiment” and “an embodiment” represent “at least one embodiment”. The term “another embodiment” means “at least one other embodiment”. The terms “first”, “second”, etc. can refer to different objects or the same object. Other definitions, whether explicit or implicit, can be included below. Unless expressly stated in the context, the definition of one term is consistent throughout this specification.

In this specification, the term “application” may be a concept in a research and development phase. A set of codes can correspond to an “application”. “Application” may have a plurality of attributes, for example, an architecture and a domain used for development, a development owner, a corresponding code repository, and a version list.

The following describes in detail batch scheduling-based application scheduling methods, apparatuses, and systems according to embodiments of this specification with reference to the accompanying drawings.

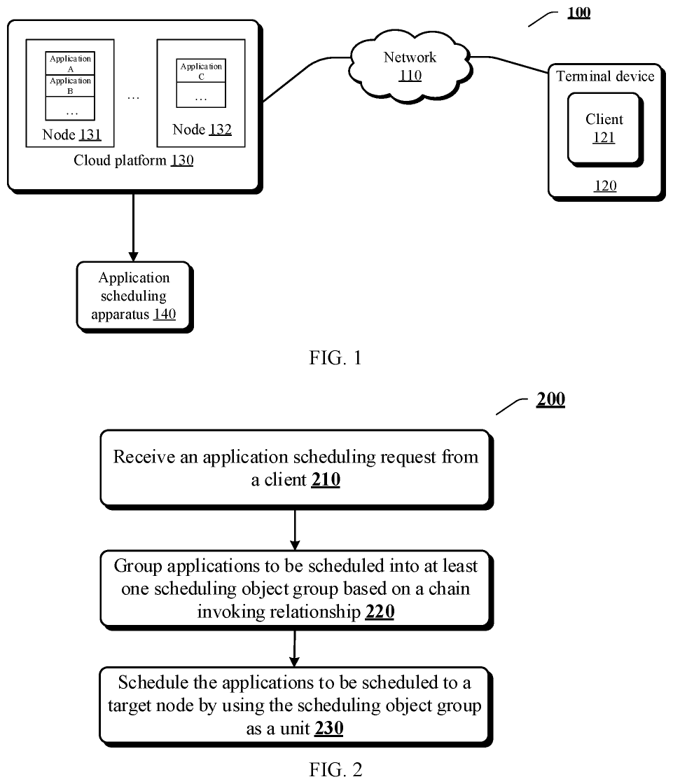

FIG. 1 illustrates an example architecture 100 of a batch scheduling-based application scheduling method, apparatus, and system, according to one or more embodiments of this specification.

In FIG. 1, a network 110 can be used for interconnection between a terminal device 120 and a cloud platform 130.

The network 110 can be any type of network that can interconnect network entities. The network 110 can be a single network or a combination of various networks. In terms of coverage, the network 110 can be a local area network (LAN), a wide area network (WAN), etc. In terms of bearing medium, the network 110 can be a wired network, a wireless network, etc. In terms of data exchange technology, the network 110 can be a circuit switched network, a packet switched network, etc.

The terminal device 120 can be any type of electronic computing device that can be connected to the network 110, access a server or website on the network 110, process data or signals, etc. For example, the terminal device 120 can be a desktop computer, a laptop computer, a tablet computer, a smartphone, etc. Although only one terminal device is shown in FIG. 1, it should be understood that different quantities of terminal devices can be connected to the network 110.

In an implementation, the terminal device 120 can be used by a user. The terminal device 120 can include an application client (such as a client 121) that provides various services for a user. In some cases, the client 121 can interact with the cloud platform 130. For example, the client 121 can transmit a message input by a user to the cloud platform 130 and receive a response associated with the message from the cloud platform 130. In this specification, “message” can refer to any input information, such as application scheduling information input by a user.

The cloud platform 130 can be connected to an application scheduling apparatus 140 by using a network. The application scheduling apparatus 140 can be configured to support the cloud platform 130 to schedule an application to a node 131, a node 132, etc. for running.

It should be understood that, all network entities shown in FIG. 1 are examples. Based on a specific application need, the architecture 100 can relate to any other network entity.

FIG. 2 is a flowchart illustrating a batch scheduling-based application scheduling method 200, according to one or more embodiments of this specification.

As shown in FIG. 2, in 210, an application scheduling request is received from a client.

In this embodiment, the application scheduling request can be received from the client. The application scheduling request can include description information used to indicate a chain invoking relationship between applications to be scheduled. It can be understood that, the application scheduling request can further include a storage path of code corresponding to each application to be scheduled, so that a corresponding application to be scheduled is scheduled to a node on a cloud platform for running.

In an example, the chain invoking relationship is used to indicate a mutual invoking relationship between different applications. For example, on a payment link, application A serving as an ingress application may invoke application B, and application B may also invoke application C, so that a chain invoking relationship is formed between application A, application B, and application C. Optionally, a certain application (for example, a payment application) can also exist on a plurality of links (for example, a payment link).

In some optional implementations of this embodiment, the application scheduling request can further include resource occupation information. In an example, the resource occupation information can be used to indicate resources needed by an application to be scheduled. For example, the resource occupation information can be used to indicate resources respectively needed by the applications to be scheduled. For another example, the resource occupation information can be used to indicate a total quantity of resources needed by the applications to be scheduled. For still another example, the resource occupation information can be used to indicate a total quantity of resources needed by applications to be scheduled that belong to the same chain invoking relationship. In an example, the resources can be, for example, cloud resources, which can include processor resources, memory resources, disk resources, network bandwidths, etc.

In an example, the resource occupation information can be “application A—a 16-core processor, a 16G memory, and a 90G disk; and application B—a 8-core processor, a 16G memory, and a 90G disk”. In an example, the resource occupation information can be “application A and application B—a 24-core processor, a 32G memory, and a 180G disk”. In an example, the resource occupation information can be “application A and application C belonging to the same chain invoking relationship—a 24-core processor, a 32G memory, and a 180G disk”.

In 220, the applications to be scheduled are grouped into at least one scheduling object group based on the chain invoking relationship.

In this embodiment, the applications to be scheduled can be grouped into at least one scheduling object group based on the chain invoking relationship. Applications to be scheduled that are located in the same scheduling object group have the same chain invoking relationship. In an example, the applications to be scheduled can include application A, application B, application C, and application D. Application C can invoke application B and application B can invoke application A, that is, application A, application B and application C have the same chain invoking relationship. In addition, application A can invoke application D, that is, application A and application D have the same chain invoking relationship. In this case, at least two of application A, application B, and application C can be group into the same scheduling object group.

In an example, Kubernetes (K8s) is used as an example. A CR (Custom Resource, custom resource in K8s) can be predefined, for example, a scheduling object group resource (Pod Group CR). Then, at least one scheduling object group (PodGroup) can be created. One scheduling object group can be associated with a plurality of scheduling objects (Pods), so that a plurality of scheduling objects are deployed together. For example, scheduling objects corresponding to applications to be scheduled that are allocated to the same scheduling object group can be labeled to associate the applications to be scheduled with the scheduling object group. A value of the label can be a name (PodGroup Name) of the scheduling object group that includes the scheduling objects.

In some optional implementations of this embodiment, each scheduling object group can include all applications to be scheduled that have the same chain invoking relationship. In the above example, application A, application B, and application C have the same chain invoking relationship, and application A and application D have the same chain invoking relationship. In an example, application A, application B, and application C can be grouped into the same scheduling object group. In an example, application A and application D can be grouped into the same scheduling object group. In an example, application A, application B, application C, and application D can be further grouped into the same scheduling object group.

In some optional implementations of this embodiment, the application scheduling request can further include resource occupation information. The applications to be scheduled can be grouped into at least one scheduling object group based on the chain invoking relationship and the resource occupation information. Applications to be scheduled that are located in the same scheduling object group have the same chain invoking relationship and satisfy a resource occupation limitation condition.

In an example, the resource occupation limitation condition can include that a total quantity of resources indicated by the resource occupation information corresponding to the applications to be scheduled that are allocated to the same scheduling object group does not exceed a predetermined threshold. For example, if a total quantity of resources indicated by the resource occupation information corresponding to application A, application B, and application C that belong to the same chain invoking relationship exceeds the predetermined threshold, only two of application A, application B, and application C that satisfy the resource occupation limitation condition can be grouped into the same scheduling object group.

In an example, the resource occupation limitation condition can include that the resource occupation information corresponding to scheduling object groups is evenly allocated as far as possible. For example, application A, application B, and application C have the same chain invoking relationship, application A, and application D have the same chain invoking relationship, and the resource occupation information respectively corresponding to application A, application B, application C, and application D is similar. In this case, application A and application D can be grouped into the same scheduling object group, and application B and application C can be grouped into another scheduling object group.

In some optional implementations of this embodiment, scheduling objects in the scheduling object group can be in a one-to-one mapping relationship with applications to be deployed in the scheduling object group. In an example, K8s is used as an example. For each scheduling object group, applications to be scheduled that are allocated to the scheduling object group (PodGroup) can be deployed in containers of respective scheduling objects (Pods) of the applications to be scheduled. Therefore, applications to be scheduled that belong to the same chain invoking relationship can be separately deployed by using scheduling objects respectively corresponding to the applications to be scheduled. The applications are deployed in different containers to improve isolation between the applications. In addition, different containers are respectively located in different scheduling objects, to avoid a port conflict caused by a single scheduling object having a plurality of containers.

In 230, the applications to be scheduled are scheduled to a target node by using the scheduling object group as a unit.

In this embodiment, the applications to be scheduled can be scheduled to the target node by using the scheduling object group as a unit. In an example, the applications to be scheduled can be scheduled to the target node by using the scheduling object group as a unit. Optionally, a minimum successful scheduling quantity (minMember) can be set to schedule the applications to be scheduled to the target node by using the scheduling object group as a unit.

In an example, for each scheduling object group, it can be determined whether a target node that satisfies a deployment need of the scheduling object group exists in a current schedulable node, so that scheduling objects in the scheduling object group run on the target node together. The scheduling object group can be scheduled to the target node in response to determining that the target node exists. It can be understood that, if there are a plurality of target nodes that satisfy the deployment need of the scheduling object group, one target node can be selected from the plurality of target nodes, and the scheduling object group is scheduled to the selected target node. Therefore, applications to be scheduled that have the same chain invoking relationship can be deployed in scheduling objects in a scheduling object group running on the same physical machine. In addition, independent applications are used as orchestration objects in an object group to be scheduled, and no combination of a code level is needed, thereby implementing application development insensibility.

In an example, a quantity of scheduling object groups running on the target node is less than a predetermined combined deployment quantity threshold. As such, a maximum combined deployment quantity on a single node can be constrained to scatter combined deployment, thereby implementing load balancing.

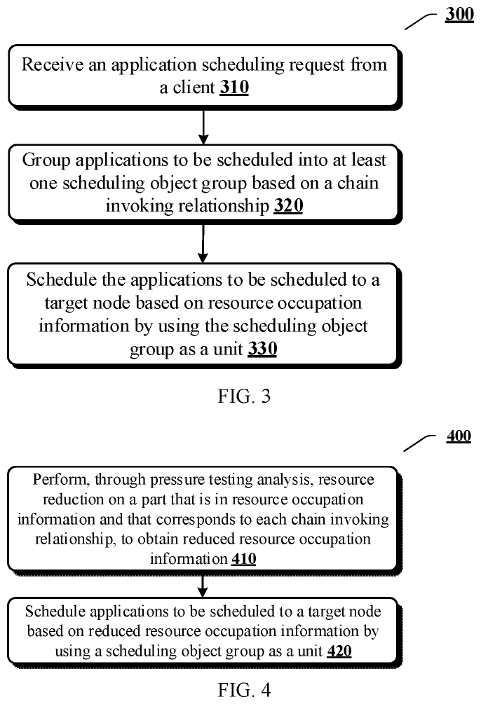

Referring to FIG. 3, FIG. 3 is another example flowchart illustrating a batch scheduling-based application scheduling method 300, according to one or more embodiments of this specification.

As shown in FIG. 3, in 310, an application scheduling request is received from a client.

In this embodiment, the application scheduling request can include description information used to indicate a chain invoking relationship between applications to be scheduled and resource occupation information.

In 320, the applications to be scheduled are grouped into at least one scheduling object group based on the chain invoking relationship.

In this embodiment, applications to be scheduled that are located in the same scheduling object group have the same chain invoking relationship.

It is worthwhile to note that, for step 310 and step 320, references can be made to related descriptions of step 210 and step 220 in the embodiment in FIG. 2. Details are omitted here for simplicity.

In 330, the applications to be scheduled are scheduled to a target node based on the resource occupation information by using the scheduling object group as a unit.

In an example, references can be made to Gang scheduling (All-or-Nothing) in a Volcano system to schedule the applications to be scheduled to the target node by using the scheduling object group as a unit. Optionally, a minimum successful scheduling quantity can be set to schedule the applications to be scheduled to the target node by using the scheduling object group as a unit. In this case, a value of the minimum successful scheduling quantity can be less than a total quantity of scheduling objects associated with the scheduling object group.

In an example, for each scheduling object group, it can be determined whether a target node that satisfies a deployment resource need (for example, a quantity of idle resources is greater than a total quantity of occupied resources indicated by the resource occupation information of the scheduling object group) of the scheduling object group exists in a current schedulable node, so that scheduling objects in the scheduling object group run on the target node together. The scheduling object group can be scheduled to the target node in response to determining that the target node exists. Therefore, applications to be scheduled that have the same chain invoking relationship can be deployed in scheduling objects in a scheduling object group running on the same physical machine.

In some optional implementations of this embodiment, the applications to be scheduled can be scheduled to the target node based on the resource occupation information and a load balancing algorithm by using the scheduling object group as a unit. In an example, for each scheduling object group, when there are a plurality of target nodes that satisfy a deployment need of the scheduling object group, the scheduling object group can be scheduled to a relatively idle target node based on the load balancing algorithm, thereby improving system performance.

Optionally, referring to FIG. 4, FIG. 4 is an example flowchart illustrating an application scheduling process 400, according to one or more embodiments of this specification.

In 410, resource reduction is performed, through pressure testing analysis, on a part that is in resource occupation information and that corresponds to each chain invoking relationship, to obtain reduced resource occupation information.

In this embodiment, each scheduling object group can include all applications to be scheduled that have the same chain invoking relationship. For each chain invoking relationship, resources corresponding to the chain invoking relationship can be reduced through pressure testing analysis, to obtain reduced resource occupation information. In an example, chain invoking relationship 1 can include application A, application B, and application C, chain invoking relationship 2 can include application A and application D, and the resource occupation information can be used to indicate resources respectively needed by applications to be scheduled (for example, application A, application B, application C, and application D). In this case, parts in the resource occupation information that correspond to chain invoking relationships (for example, chain invoking relationship 1 and chain invoking relationship 2) can be respectively determined based on a sum of resources needed by application A, application B, and application C (for example, a 32-core processor, a 48G memory, and a 180G disk), and a sum of resources needed by application A and application D. In an example, the resource occupation information can be used to indicate a total quantity of resources needed by applications to be scheduled that belong to the same chain invoking relationship (for example, application A, application B, and application C that belong to chain invoking relationship 1, and application A and application D that belong to chain invoking relationship 2). In this case, parts in the resource occupation information that correspond to chain invoking relationships can be directly obtained.

In an example, for each chain invoking relationship, performance of applications to be scheduled (for example, application A, application B, and application C) in a scheduling object group corresponding to the chain invoking relationship can be tested based on test target values corresponding to the applications to be scheduled. Specifically, all applications to be scheduled in the scheduling object group corresponding to the chain invoking relationship can be deployed on the same physical machine, so as to continuously improve access traffic and observe target value resource usage information generated when each application to be scheduled reaches a corresponding test target value. The test target value can be, for example, peak values of QPS (Query Per Second) and RT (Response Time) of each application to be scheduled. The target value resource usage information can be, for example, resource usage of each application to be scheduled, for example, CPU utilization, memory utilization, and disk utilization. Then, resource evaluation and reduction can be performed based on the target value resource usage information corresponding to each application to be scheduled, to obtain reduced resource usage corresponding to the application to be scheduled. Afterwards, a total quantity of combined deployment resources (for example, a 24-core processor, a 48G memory, and a 180G disk) corresponding to the scheduling object group can be determined based on the reduced resource usage corresponding to each application to be deployed. The total quantity of combined deployment resources is not greater than a total quantity of resources corresponding to the chain invoking relationship.

Optionally, the reduced resource usage corresponding to each application to be scheduled can be determined based on a reduction proportion of the total quantity of combined deployment resources. In an example, as described above, resource occupation information corresponding to applications to be scheduled that belong to chain invoking relationship 1 can be “application A—a 16-core processor; application B—a 8-core processor; and application C—a 8-core processor”. In this case, a part that is in the resource occupation information and that corresponds to chain invoking relationship 1 can be a “32-core processor”, and a corresponding total quantity of combined deployment resources can be a 24-core processor. Therefore, the reduced resource usage corresponding to application A can be a “16×24/32=12-core processor”. Similarly, the reduced resource usage respectively corresponding to application B and application C can be a “8×24/32=6-core processor”.

In 420, the applications to be scheduled are scheduled to a target node based on the reduced resource occupation information by using the scheduling object group as a unit.

In this embodiment, references can be made to the related description of step 330 in the embodiment in FIG. 3, except that the “resource occupation information” is replaced with the “reduced resource occupation information”. Details are omitted here for simplicity.

Based on this, tidal characteristics (that is, a resource of one application is used in a wave peak, and a resource of another application is used in a wave valley) inherent to resource use of applications that belong to the same invoking chain can be effectively used. Through combined deployment, a resource margin applied for due to stability and availability considerations when applications to be deployed are deployed independently. Therefore, hardware resources are effectively reduced. In addition, because a size of a reduced scheduling object group becomes smaller, the reduced scheduling object group is easier to be successfully scheduled than a large-sized scheduling object group that is prone to have resource fragments, thereby helping improve a success rate of combined deployment.

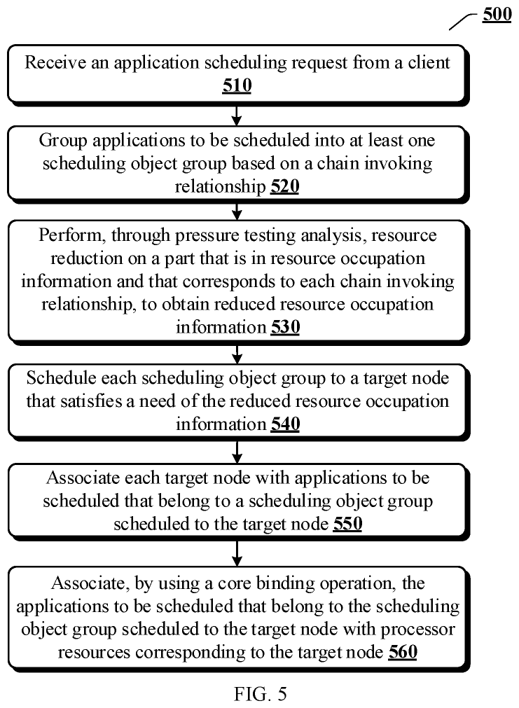

Optionally, referring to FIG. 5, FIG. 5 is still another example flowchart illustrating a batch scheduling-based application scheduling method 500, according to one or more embodiments of this specification.

In 510, an application scheduling request is received from a client.

In this embodiment, the application scheduling request can further include resource occupation information. The resource occupation information includes a total quantity of occupied processor resources. In an example, the total quantity of occupied processor resources can be, for example, a quantity of cores of a CPU.

In 520, applications to be scheduled are grouped into at least one scheduling object group based on a chain invoking relationship.

In this embodiment, each scheduling object group can include all applications to be scheduled that have the same chain invoking relationship.

In 530, resource reduction is performed, through pressure testing analysis, on a part that is in the resource occupation information and that corresponds to each chain invoking relationship, to obtain reduced resource occupation information.

In 540, each scheduling object group is scheduled to a target node that satisfies a need of the reduced resource occupation information.

In an example, K8s is used as an example. A node that does not satisfy the need of the reduced resource occupation information can be filtered out by using a scheduler of K8s. Subsequently, references can be made to the scheduling method described in the above embodiment to attempt to schedule each scheduling object group to a corresponding target node.

In 550, each target node is associated with applications to be scheduled that belong to a scheduling object group scheduled to the target node.

In an example, K8s is used as an example. Each target node can be bound to a scheduling object group scheduled to the target node by using the scheduler of K8s. Therefore, through association between the scheduling object group and applications to be scheduled that are allocated to the scheduling object group, the target node can be associated with the applications to be scheduled that belong to the scheduling object group scheduled to the target node.

In 560, the applications to be scheduled that belong to the scheduling object group scheduled to the target node are associated with processor resources corresponding to the target node by using a core binding operation, so that the applications to be scheduled that belong to the scheduling object group scheduled to the target node share a bound processor core group.

In this embodiment, the core binding operation can be used to enable scheduling objects in the same scheduling object group to share processor resources. In an example, for example, a scheduling object group (for example, PodGroup A) is scheduled to a target node (for example, a node x), and reduced resource occupation information is 12 CPU cores. In this case, an affinity between a process that runs the applications to be scheduled (for example, application 1, application 2, and application 3) that belong to the scheduling object group and a CPU core group (for example, including 12 CPU cores) corresponding to the target node can be set, so that the applications to be scheduled (for example, application 1, application 2, and application 3) that belong to the scheduling object group run only in a core that belongs to the CPU core group and share the CPU core group.

Based on this, the core binding operation is performed to enable applications to be scheduled that belong to the same scheduling object group to share a bound core group, to implement overselling of combined deployment resources, and provide more elastic resources to the applications to be scheduled that belong to the same scheduling object group.

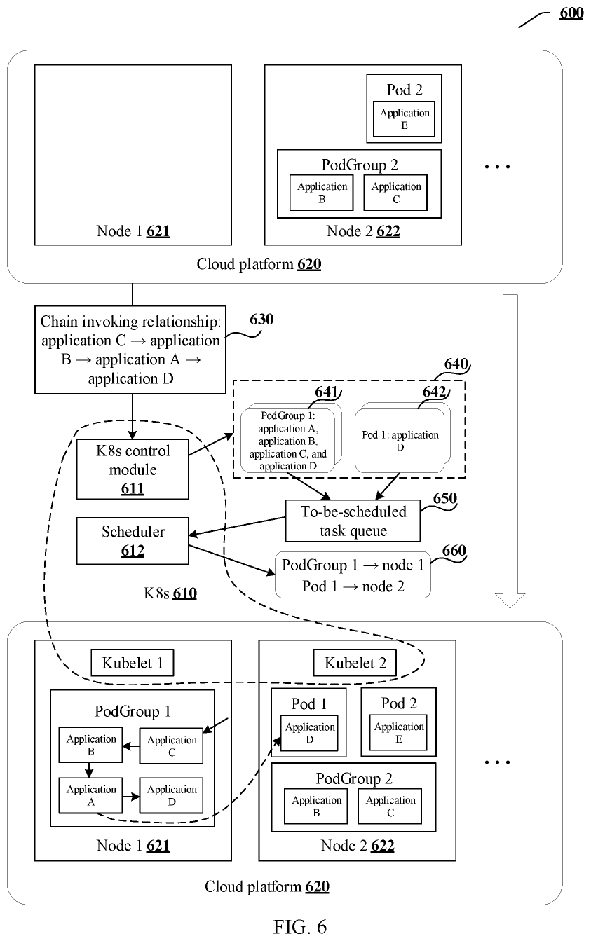

Referring to FIG. 6, FIG. 6 is an example schematic diagram illustrating an application scenario 600 of a batch scheduling-based application scheduling method, according to one or more embodiments of this specification.

As shown in FIG. 6, the batch scheduling-based application scheduling method can be applied to a K8s-based application orchestration system (as shown by 610 in FIG. 6). Node 1 (shown by 621 in FIG. 6) and node 2 (shown by 622 in FIG. 6) can run on a cloud platform 620 in FIG. 6. In an initial state, scheduling object Pod 2 and scheduling object group PodGroup 2 can run on node 2, application E can run in a container of scheduling object Pod 2, and application B and application C can run in a container of scheduling object group PodGroup 2. The cloud platform 620 can receive an application scheduling request from a client. The application scheduling request can include description information used to indicate a chain invoking relationship 630 in FIG. 6. Then, the cloud platform 620 can send the application scheduling request and a defined scheduling object group PodGroup to a K8s control module 611 (usually located on a master node) by using an adaptation layer interface (Adapter Api). The chain invoking relationship 630 indicates that application C can invoke application B, application B can invoke application A, and application A can invoke application D. Based on this, the K8s control module 611 can group the applications to be scheduled (for example, application A, application B, application C, and application D) into at least one scheduling object group 640. Applications to be scheduled that are located in the same scheduling object group have the same chain invoking relationship. In an example, application A, application B, application C, and application D can be grouped into scheduling object group PodGroup 1 (as shown by 641 in the figure). In an example, application D can be grouped into scheduling object Pod 1 (as shown by 642 in the figure).

After watching the created scheduling object group PodGroup 1 and scheduling object Pod 1, a scheduler 612 of K8s enqueues object group PodGroup 1 and scheduling object Pod 1 to a to-be-scheduled task queue 650. Afterwards, the scheduler 612 of K8s can schedule a scheduling object group or a scheduling object dequeued from the to-be-scheduled task queue 650 to a target node (as shown by 660 in FIG. 6). When a scheduling object group is dequeued, scheduling objects in the scheduling object group are scheduled to the same node. Then, after watching scheduling information indicated by 660 in the figure, Kubelet 1 and Kubelet 2 that run on a slave node separately invoke Docker on the current node to start a container, so as to run a corresponding application. After the container is successfully started, application A, application B, application C, and application D can run on node 1 (as shown in 621 in FIG. 6) together on the cloud platform 620 in a form of scheduling object group PodGroup 1, and application D can run on node 2 (as shown by 622 in FIG. 6) on the cloud platform 620 in a form of scheduling object Pod 1.

Optionally, when application A needs to invoke application D, application D that belongs to the same scheduling object group PodGroup 1 as application A is preferentially invoked, and application D located on a different node (such as Pod 1) is invoked only when single-machine invoking fails. Therefore, a remote RPC (Remote Procedure Call) is switched to a single-node call as far as possible, so that communication resources can be significantly reduced.

Optionally, in an example, the scheduler 612 of K8s can schedule a scheduling object group or a scheduling object dequeued from the to-be-scheduled task queue 650 to the target node in the following method. A batch scheduling function AllocateBatch( ) similar to AllocateNew( ) can be added to schedule a PodGroup. AllocateBatch( ) can generate a corresponding scheduling object based on a quantity of applications to be scheduled included in each scheduling object group. A pack operation is performed on each scheduling object, that is, whether a node that enables the scheduling object to be successfully scheduled exists in a current schedulable node is determined based on a scheduling policy. The scheduling policy includes scheduling, to the same node, scheduling objects in the same scheduling object group. When at least a minimum successful scheduling quantity of scheduling objects in the scheduling object group can be successfully scheduled, the scheduling object group can be successfully scheduled to the target node, and a bind operation is performed on the scheduling objects in the scheduling object group. Otherwise, the current scheduling of the scheduling object group fails.

Optionally, the scheduling object group can be deleted by using Finalizers to release resources.

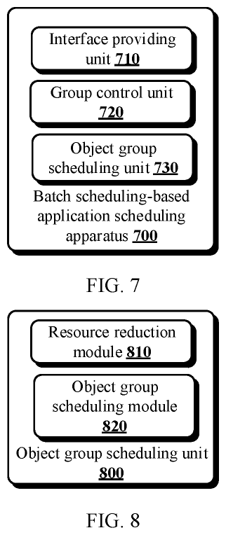

FIG. 7 is an example block diagram illustrating a batch scheduling-based application scheduling apparatus 700, according to one or more embodiments of this specification. The apparatus embodiment can correspond to the method embodiments shown in FIG. 2 to FIG. 6, and the apparatus can be specifically applied to various electronic devices.

As shown in FIG. 7, the batch scheduling-based application scheduling apparatus 700 can include an interface providing unit 710, a group control unit 720, and an object group scheduling unit 730.

The interface providing unit 710 is configured to receive an application scheduling request from a client. The application scheduling request includes description information used to indicate a chain invocation relationship between applications to be scheduled. For the operation of the interface providing unit 710, references can be made to the operation in 210 described in FIG. 2.

The group control unit 720 is configured to group the applications to be scheduled into at least one scheduling object group based on the chain invoking relationship. Applications to be scheduled that are located in the same scheduling object group have the same chain invoking relationship. For the operation of the group control unit 720, references can be made to the operation in 220 described in FIG. 2.

In an example, each scheduling object group includes all applications to be scheduled that have the same chain invoking relationship. References can be made to related description of the optional implementation of step 220 in the embodiment of FIG. 2.

In an example, the application scheduling request further includes resource occupation information. The group control unit 720 is further configured to group the applications to be scheduled into at least one scheduling object group based on the chain invoking relationship and the resource occupation information. Applications to be scheduled that are located in the same scheduling object group have the same chain invoking relationship and satisfy a resource occupation limitation condition. References can be made to related description of the optional implementation of step 220 in the embodiment of FIG. 2.

The object group scheduling unit 730 is configured to schedule the applications to be scheduled to a target node by using the scheduling object group as a unit. For the operation of the object group scheduling unit 730, references can be made to the operation in 230 described in FIG. 2.

In an example, the application scheduling request further includes resource occupation information. The object group scheduling unit 730 is further configured to schedule the applications to be scheduled to the target node based on the resource occupation information by using the scheduling object group as a unit. References can be made to related description of step 330 in the embodiment of FIG. 3.

In an example, the object scheduling unit 730 is further configured to schedule the applications to be scheduled to the target node based on the resource occupation information and a load balancing algorithm by using the scheduling object group as a unit. References can be made to related description of the optional implementation of step 330 in the embodiment of FIG. 3.

Referring to FIG. 8, FIG. 8 is an example block diagram illustrating an object group scheduling unit 800 in a batch scheduling-based application scheduling apparatus, according to one or more embodiments of this specification.

As shown in FIG. 8, the object group scheduling unit 800 can include a resource reduction module 810 and an object group scheduling module 820.

The resource reduction module 810 is configured to perform, through pressure testing analysis, resource reduction on a part that is in the resource occupation information and that corresponds to each chain invoking relationship, to obtain reduced resource occupation information. For the operation of the resource reduction module 810, references can be made to the operation in 410 described in FIG. 4.

The object group scheduling module 820 is configured to schedule the applications to be scheduled to the target node based on the reduced resource occupation information by using the scheduling object group as a unit. For the operation of the object group scheduling module 820, references can be made to the operation in 420 described in FIG. 4.

In an example, the resource occupation information includes a total quantity of occupied processor resources. The object group scheduling module 820 is further configured to schedule each scheduling object group to a target node that satisfies a need of the reduced resource occupation information; associate each target node with applications to be scheduled that belong to a scheduling object group scheduled to the target node; and associate, by using a core binding operation, the applications to be scheduled that belong to the scheduling object group scheduled to the target node with processor resources corresponding to the target node, so that the applications to be scheduled that belong to the scheduling object group scheduled to the target node share a bound processor core group. For the operations of the object group scheduling module 820, references can be made to the operations in 540 to 560 described in FIG. 5.

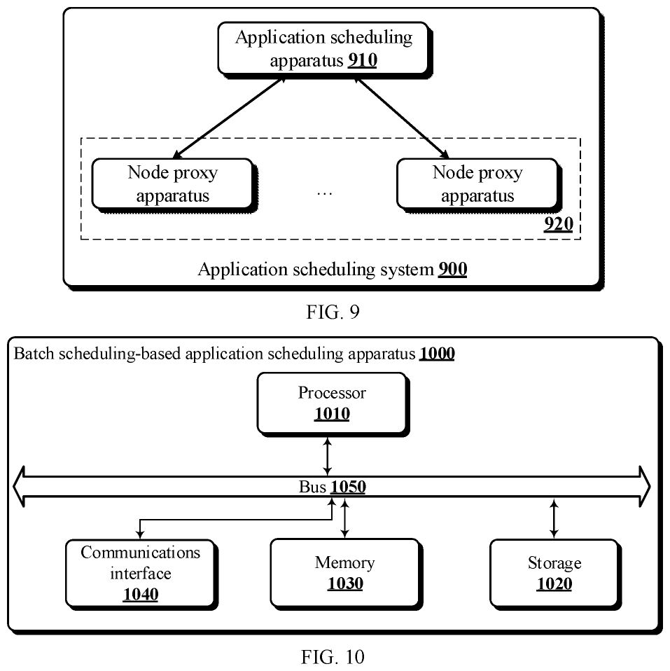

Referring to FIG. 9, FIG. 9 is an example schematic diagram illustrating a batch scheduling-based application scheduling system, according to one or more embodiments of this specification.

As shown in FIG. 9, the application scheduling system 900 can include an application scheduling apparatus 910 and a node proxy apparatus 920. For operations of the application scheduling apparatus 910, references can be made to the operations described in FIG. 2 to FIG. 6. The node proxy apparatus 920 is configured to manage each scheduling object in the scheduling object group and a container that is in each scheduling object and that is used to run an application to be scheduled. In an example, in a cluster, the application scheduling apparatus 910 is usually disposed on a master node, and a plurality of node proxy apparatuses 920 can be disposed on a slave node. In an example, the application scheduling apparatus 910 can be obtained through improvement based on a Master component of K8s. In this case, the node proxy apparatus 920 can be obtained through improvement based on a Kubelet component.

Embodiments of the batch scheduling-based application scheduling method, apparatus, and system according to the embodiments of this specification are described above with reference to FIG. 1 to FIG. 9.

The batch scheduling-based application scheduling apparatus in the embodiments of this specification can be implemented by hardware, or can be implemented by software or a combination of hardware and software. Software implementation is used as an example. As a logical apparatus, the apparatus is formed by reading a corresponding computer program instruction in a storage to a memory by a processor of a device where the device is located. In the embodiments of this specification, the batch scheduling-based application scheduling apparatus can be implemented by using, for example, an electronic device.

FIG. 10 is an example schematic diagram illustrating a batch scheduling-based application scheduling apparatus 1000, according to one or more embodiments of this specification.

As shown in FIG. 10, the batch scheduling-based application scheduling apparatus 1000 can include at least one processor 1010, a storage (for example, a non-volatile storage) 1020, a memory 1030, and a communication interface 1040, and the at least one processor 1010, the storage 1020, the memory 1030, and the communication interface 1040 are connected together by using a bus 1050. The at least one processor 1010 executes at least one computer-readable instruction (namely, the above-mentioned elements implemented in a software form) stored or encoded in the storage.

In one or more embodiments, computer-executable instructions are stored in the storage. When the computer-executable instructions are executed, then at least one processor 1010 is enabled to receive an application scheduling request from a client, where the application scheduling request includes description information used to indicate a chain invoking relationship between applications to be scheduled; group the applications to be scheduled into at least one scheduling object group based on the chain invoking relationship, where applications to be scheduled that are located in the same scheduling object group have the same chain invoking relationship; and schedule the applications to be scheduled to a target node by using the scheduling object group as a unit.

It should be understood that, when the computer-executable instructions stored in the storage are executed, the at least one processor 1010 is enabled to perform the above-mentioned operations and functions described with reference to FIG. 1 to FIG. 6 in the embodiments of this specification.

According to one or more embodiments, a program product such as a computer-readable medium is provided. The computer-readable medium may have instructions (that is, the above-mentioned elements implemented in a software form). When the instructions are executed by a computer, the computer is enabled to perform the above-mentioned operations and functions described with reference to FIG. 1 to FIG. 6 in the embodiments of this specification.

Specifically, a system or an apparatus equipped with a readable storage medium can be provided, and software program code for implementing the functions in any of the above-mentioned embodiments is stored in the readable storage medium, so that a computer or a processor of the system or the apparatus reads and executes instructions stored in the readable storage medium.

In this case, the program code read from the readable medium can implement the functions in any one of the embodiments described above, and therefore the machine-readable code and the readable storage medium storing the machine-readable code form a part of this specification.

Computer program code needed for operation of each part of this specification can be written in any one or more programming languages, including object-oriented programming languages such as Java, Scala, Smalltalk, Eiffel, JADE, Emerald, C++, C #, VB, NET, and Python, conventional programming languages such as C language, Visual Basic 2003, Perl, COBOL 2002, PHP, and ABAP, dynamic programming languages such as Python, Ruby, and Groovy, or other programming languages. The program code can run on a user computer, or run as an independent software package on a user computer, or partially run on a user computer and partially run on a remote computer, or run entirely on a remote computer or server. In the latter case, the remote computer can be connected to a user computer through any form of network, such as a local area network (LAN) or a wide area network (WAN), or connected to an external computer (for example, through the Internet), or in a cloud computing environment, or used as a service, such as software as a service (SaaS).

Embodiments of the readable storage medium include a floppy disk, a hard disk, a magneto-optical disk, an optical disc (such as a CD-ROM, a CD-R, a CD-RW, a DVD-ROM, a DVD-RAM, a DVD-RW, a DVD-RW), a magnetic tape, a non-volatile storage card, and a ROM. Alternatively, the program code can be downloaded from a server computer or a cloud by a communication network.

Specific embodiments of this specification are described above. Other embodiments fall within the scope of the appended claims. In some cases, actions or steps described in the claims can be performed in an order different from that in the embodiments and desired results can still be achieved. In addition, the process depicted in the accompanying drawings does not necessarily need a particular order or sequential order to achieve the desired results. In some implementations, multi-tasking and parallel processing are feasible or may be advantageous.

Not all steps and units in the previous processes and system structure diagrams are needed. Some steps or units can be ignored based on actual needs. An execution order of the steps is not fixed, and can be determined based on needs. The apparatus structure described in the above-mentioned embodiments can be a physical structure, or can be a logical structure. In other words, some units can be implemented by the same physical entity, or some units can be implemented by a plurality of physical entities or implemented jointly by some components in a plurality of independent devices.

The term “example” used throughout this specification means “used as an example, an instance, or an illustration” and does not mean “preferred” or “advantageous” over other embodiments. For the purpose of providing an understanding of the described technology, a specific implementation includes specific details. However, these technologies can be implemented without these specific details. In some instances, to avoid obscuring the described concepts in the embodiments, well-known structures and apparatuses are shown in the form of a block diagram.

Optional implementations of the embodiments of this specification are described in detail with reference to the accompanying drawings. However, the embodiments of this specification are not limited to specific details in the previous implementations. Within a technical concept scope of the embodiments of this specification, a plurality of simple variations of the technical solutions of the embodiments of this specification can be made, and these simple variations are all within the protection scope of the embodiments of this specification.

The previous descriptions of the content in this specification are provided to enable any person of ordinary skill in the art to implement or use the content in this specification. It is obvious to a person of ordinary skill in the art that various modifications can be made to the content in this specification. In addition, the general principle defined in this specification can be applied to another variant without departing from the protection scope of the content in this specification. Therefore, the content in this specification is not limited to the examples and designs described here, but is consistent with the widest scope of principles and novelty features that conform to this specification.

What is claimed is:

1. A application scheduling method, comprising:
receiving an application scheduling request from a client, wherein the application scheduling request comprises description information used to indicate a chain invoking relationship between applications to be scheduled;
grouping the applications to be scheduled into at least one scheduling object group based on the chain invoking relationship, wherein applications to be scheduled that are located in the same scheduling object group have the same chain invoking relationship; and
scheduling the applications to be scheduled to a target node by using the scheduling object group as a unit.

2. The application scheduling method according to claim 1, wherein each scheduling object group comprises all applications to be scheduled that have the same chain invoking relationship.

3. The application scheduling method according to claim 1, wherein the application scheduling request further comprises resource occupation information; and
the grouping the applications to be scheduled into at least one scheduling object group based on the chain invoking relationship comprises:
grouping the applications to be scheduled into at least one scheduling object group based on the chain invoking relationship and the resource occupation information, wherein applications to be scheduled that are located in the same scheduling object group have the same chain invoking relationship and satisfy a resource occupation limitation condition.

4. The application scheduling method according to claim 1, wherein the application scheduling request further comprises resource occupation information; and
the scheduling the applications to be scheduled to a target node by using the scheduling object group as a unit comprises:
scheduling the applications to be scheduled to the target node based on the resource occupation information by using the scheduling object group as a unit.

5. The application scheduling method according to claim 4, wherein the scheduling the applications to be scheduled to the target node based on the resource occupation information by using the scheduling object group as a unit comprises:
scheduling the applications to be scheduled to the target node based on the resource occupation information and a load balancing algorithm by using the scheduling object group as a unit.

6. The application scheduling method according to claim 4, wherein each scheduling object group comprises all applications to be scheduled that have the same chain invoking relationship; and
the scheduling the applications to be scheduled to the target node based on the resource occupation information by using the scheduling object group as a unit comprises:
performing, through pressure testing analysis, resource reduction on a part that is in the resource occupation information and that corresponds to each chain invoking relationship, to obtain reduced resource occupation information; and
scheduling the applications to be scheduled to the target node based on the reduced resource occupation information by using the scheduling object group as a unit.

7. The application scheduling method according to claim 6, wherein the resource occupation information comprises a total quantity of occupied processor resources; and
the scheduling the applications to be scheduled to the target node based on the reduced resource occupation information by using the scheduling object group as a unit comprises:
scheduling each scheduling object group to a target node that satisfies a need of the reduced resource occupation information;
associating each target node with applications to be scheduled that belong to a scheduling object group scheduled to the target node; and
associating, by using a core binding operation, the applications to be scheduled that belong to the scheduling object group scheduled to the target node with processor resources corresponding to the target node, so that the applications to be scheduled that belong to the scheduling object group scheduled to the target node share a bound processor core group.

8. A non-transitory computer-readable storage medium having stored therein instructions that, when executed by a processor of a computing device, cause the processor to:
receive an application scheduling request from a client, wherein the application scheduling request comprises description information used to indicate a chain invoking relationship between applications to be scheduled;
group the applications to be scheduled into at least one scheduling object group based on the chain invoking relationship, wherein applications to be scheduled that are located in the same scheduling object group have the same chain invoking relationship; and
schedule the applications to be scheduled to a target node by using the scheduling object group as a unit.

9. An electronic device, comprising a memory and a processor, wherein the memory stores executable instructions that, in response to execution by the processor, cause processor to:
receive an application scheduling request from a client, wherein the application scheduling request comprises description information used to indicate a chain invoking relationship between applications to be scheduled;
group the applications to be scheduled into at least one scheduling object group based on the chain invoking relationship, wherein applications to be scheduled that are located in the same scheduling object group have the same chain invoking relationship; and
schedule the applications to be scheduled to a target node by using the scheduling object group as a unit.
